(19) United States
(12) Patent Application Publication
(10) Pub. No.: US 2018/0158488 A1
(43) Pub. Date: Jun. 7, 2018

(54) CONTINUOUS AUTOMATED SYNCHRONIZATION OF AN AUDIO TRACK IN A MOVIE THEATER

(71) Applicant: Theater Ears, LLC, Boca Raton, FL (US)

(72) Inventor: Danny Mangru, Boca Raton, FL (US)

(21) Appl. No.: 15/371,365

(22) Filed: Dec. 7, 2016

(51) Int. Cl. G11B 27/32; G06F 3/16; G11B 27/34; H04N 21/414; H04N 21/43

(52) U.S. Cl. CPC G11B 27/32; G06F 3/16; H04N 21/4307; H04N 21/41415; H04N 21/41407; G11B 27/34

(57) ABSTRACT

A method for the continuous automated audio synchronization of an alternative audio track with the playback of the combined audio and video of a motion picture includes selecting a motion picture in a user interface to an audio synchronization application executing in memory of a mobile computing device along with a corresponding movie theater in which the selected motion picture is scheduled to be presented, and downloading an alternative audio file for the selected motion picture and the corresponding movie theater. The method also includes detecting a location of the mobile computing device. Finally, in response to a determination that the mobile computing device is proximate to the movie theater, a start time of a next scheduled presentation of the selected motion picture is determined and audio synchronization of the alternative audio file triggered at a time that is within a threshold of the determined start time.

### BACKGROUND OF THE INVENTION

### Field of the Invention

The present invention relates to audio playback in a mobile device and more particularly to audio playback in coordination with external video playback.

### Description of the Related Art

Video playback refers to the presentation on a display substrate of previously recorded video imagery. Historically, video playback included merely the projection of a multiplicity of frames stored in a pancake of film onto screen—typically fabric. Audio playback simultaneously occurred with the playback of video imagery in a coordinated fashion based upon the transduction of optical patterns imprinted upon the film in association with one or more frames of imagery also imprinted upon the film. Thus, the coordination of playback of both audio and video remained the responsibility of a single projection device in the context of traditional film projection.

Unlike motion pictures, in the scholastic environment and even in the context of modern visual presentations, visual playback of a series of images such as a slide show occur separately from the playback of accompanying audio. In this regard, it is customary for the presenter to initiate playback, and in response to a particular cue, such as the presentation of a slide that states, “press play now”, the presenter can manually initiate playback of an audio cassette to audibly supplement the presentation of a series of slides in the slide show. However, the necessity of precision in coordinating the playback of the audio cassette with the presentation of different slides is lacking in that each slide of the slide show may remain visible on a presentation screen for an extended duration.

Coordinating the playback of audio separately from the projection of a film in a movie theater is not a problem of present consideration because modern file projectors manage both audio and video playback. However, circumstances arise where external audio may be desired in supplement to or in replacement of the audio inherently present during the projection of a film. For example, for an audience member who comprehends a language other than the language of a presented film and other audience members, it is desirable to simulcast audio of a language native to the audience member in lieu of the audio of the presented film that differs from the language of the audience member. Yet, coordinating the synchronized playback of the supplemental audio with the playback of the video without the cooperation of the projectionist of the film can be a manually intensive process of timing the initiation of the playback of the supplemental audio in respect to a particular cue of the film.

In recent years, several technologies have been developed in respect to the simultaneous playback of audio in connection with the presentation of a film in a movie theater. In particular, in U.S. Patent Application Publication No. 2013/0272672 by Rondon et al., a method of providing alternative audio for combined video and audio content is described in which a current playback position of the combined video and audio content is determined in a mobile device and the alternative audio is synchronized with the determined current playback position. Thereafter, the alternative audio synchronized with the current playback position is played back in the mobile device to a viewer of content such that the alternative audio replaces the original audio, which is otherwise heard by other viewers. Of note, in the Rondon patent application, the current playback position is determined through the use of watermark detection in which a watermark embedded in the combined video is detected by a microphone and mapped to a playback position in the alternative audio. Thus, absent the utilization of watermarks, synchronization of the alternative audio and the combined video is not possible.

### BRIEF SUMMARY OF THE INVENTION

Embodiments of the present invention address deficiencies of the art in respect to audio synchronization of alternative audio tracks with the presentation of combined video and provide a novel and non-obvious method, system and computer program product for the continuous automated audio synchronization of an alternative audio track with the playback of the combined audio and video of a motion picture. In an embodiment of the invention, a method for the continuous automated audio synchronization of an alternative audio track with the playback of the combined audio and video of a motion picture is provided. The method includes selecting a motion picture in a user interface to an audio synchronization application executing in memory of a mobile computing device, along with a theater in which the motion picture is scheduled to presented and start time for the motion picture at the theater, and downloading an alternative audio file for the selected motion picture. The method also includes detecting a location of the mobile computing device. Finally, in response to a determination that the mobile computing device is proximate to the selected movie theater, a start time of a next scheduled presentation of the selected motion picture is determined and audio synchronization of the alternative audio file triggered at a time that is within a threshold of the determined start time.

In one aspect of the embodiment, the audio synchronization includes receiving audio through a microphone of the mobile computing device, selecting a portion of the received audio and comparing the portion of the received audio to pre-stored audio portions in a table in the mobile computing device that maps the pre-stored audio portions to an index into the alternative audio file. As such, the portion of the received audio is matched to one of the pre-stored audio portions in the table and the alternative audio file is played back in the mobile computing device from a location indicated by an index mapped to the mapped one of the pre-stored audio portions.

In another aspect of the embodiment, multiple different movie theaters corresponding to different selected alternative audio files downloaded in connection with corresponding ones of the the theaters are geo-fenced and it is then determined that the mobile computing device is proximate to one of the movie theaters when the mobile computing device is geo-located within a geo-fence corresponding to the one of the movie theaters. In yet another aspect of the embodiment, when it is determined that audio synchronization of the alternative audio file has failed, audio synchronization is re-triggered. However, audio synchronization of the alternative audio file is discontinued in response to a manual directive received in the mobile computing device.

In another embodiment of the invention, a mobile data processing system is configured for the continuous automated audio synchronization of an alternative audio track with the playback of the combined audio and video of a motion picture. The system includes a mobile computing device with memory and at least one processor and fixed storage disposed in the mobile computing device. The system also includes an audio synchronization application executing in the memory of the mobile computing device. The application includes program code enabled upon execution to select a motion picture, corresponding theater and start times of the motion picture in a user interface to the application, download into the fixed storage an alternative audio file for the selected motion picture, detect a location of the mobile computing device, and to respond to a determination that the mobile computing device is proximate to the movie theater by determining a start time of a next scheduled presentation of the selected motion picture and triggering audio synchronization of the alternative audio file at a time that is within a threshold of the determined start time.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for the continuous automated audio synchronization of an alternative audio track with the playback of the combined audio and video of a motion picture;

FIG. 2 is a schematic illustration of a mobile data processing system configured for the continuous automated audio synchronization of an alternative audio track with the playback of the combined audio and video of a motion picture; and,

FIG. 3 is a flow chart illustrating a process for the continuous automated audio synchronization of an alternative audio track with the playback of the combined audio and video of a motion picture.

### DETAILED DESCRIPTION OF THE INVENTION

Embodiments of the invention provide for the continuous automated audio synchronization of an alternative audio track with the playback of the combined audio and video of a motion picture. In accordance with an embodiment of the invention, an alternative audio file is retrieved into fixed storage of a mobile device in connection with a particular motion picture and corresponding movie theater in which the motion picture is scheduled to be presented and a scheduled start time for the motion picture. Thereafter, a location of a mobile device is detected proximate to the movie theater. A current time is determined and a next presentation of the particular motion picture determined as well. Once the time of the next presentation is reached, a microphone in the mobile device is activated and receives audio input. The audio input is compared to known audio portions of the particular motion picture in order to identify a contemporaneously presented portion of the particular motion picture. As such, the identified contemporaneously presented portion of the particular motion picture is mapped to a location in the alternative audio file and the alternative audio file is played back from the mapped location. In this way, synchronization of the playback of the alternative audio file is achieved in an automated fashion without requiring the use of embedded watermarks in the particular motion picture.

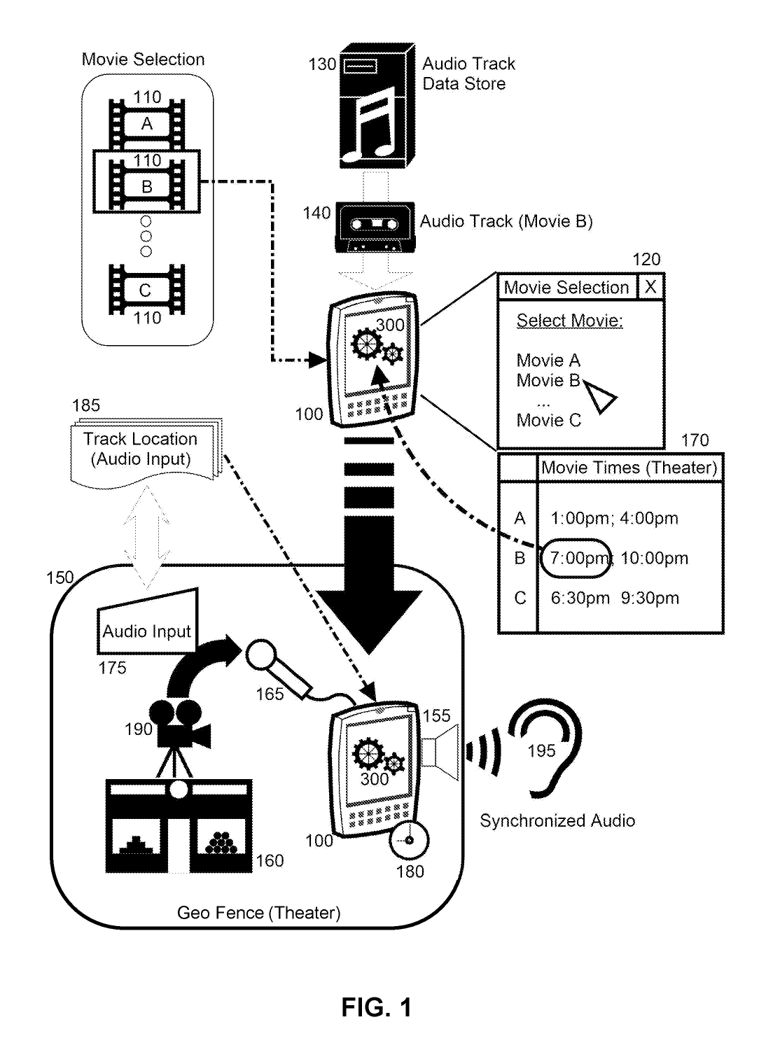

In further illustration, FIG. 1 pictorially shows a process for the continuous automated audio synchronization of an alternative audio track with the playback of the combined audio and video of a motion picture. As shown in FIG. 1, an audio synchronization module 300 executing in mobile device 100 retrieves a list of available movies 110 and presents the list in a user interface 120 displayed within the mobile device 100. Once one of the movies 110 is selected in the list, a corresponding selection of movie theaters in which the selected one of the movies 110 is scheduled to presented is selected and the audio synchronization logic 300 retrieves a listing of times 170 when the screening 190 is to occur at the selected one of the theaters 160. The audio synchronization module 300 retrieves from audio track data store 130 an audio track 140 corresponding to a selected one of the movies 110 and selected one of the theaters 160. Thereafter, the audio synchronization module 300 monitors the geographic location of the mobile device 100.

The audio synchronization module 300 detects the proximity of the mobile device 100 to the selected one of the movie theaters 160 by detecting the geographic coordinates of the mobile device 100 within a geo-fence 150 of the selected one of the movie theaters 160 in which a screening 190 of the selected one of the movies 110 is to be presented. In response to detecting the proximity of the mobile device 100 to the selected one of the movie theaters 160, a clock 180 in the mobile device 100 is then continuously monitored to determine when the screening 190 begins. Responsive to the clock 180 indicating commencement of the screening 190, microphone 165 in the mobile device 100 receives audio input 175 from the screening 190 and matches the audio input 175 to a track location 185 in the audio track 140. Finally, the audio synchronization module 300 plays back the audio track 140 beginning from the track location 185 to produce audio 195 synchronized with the screening 190.

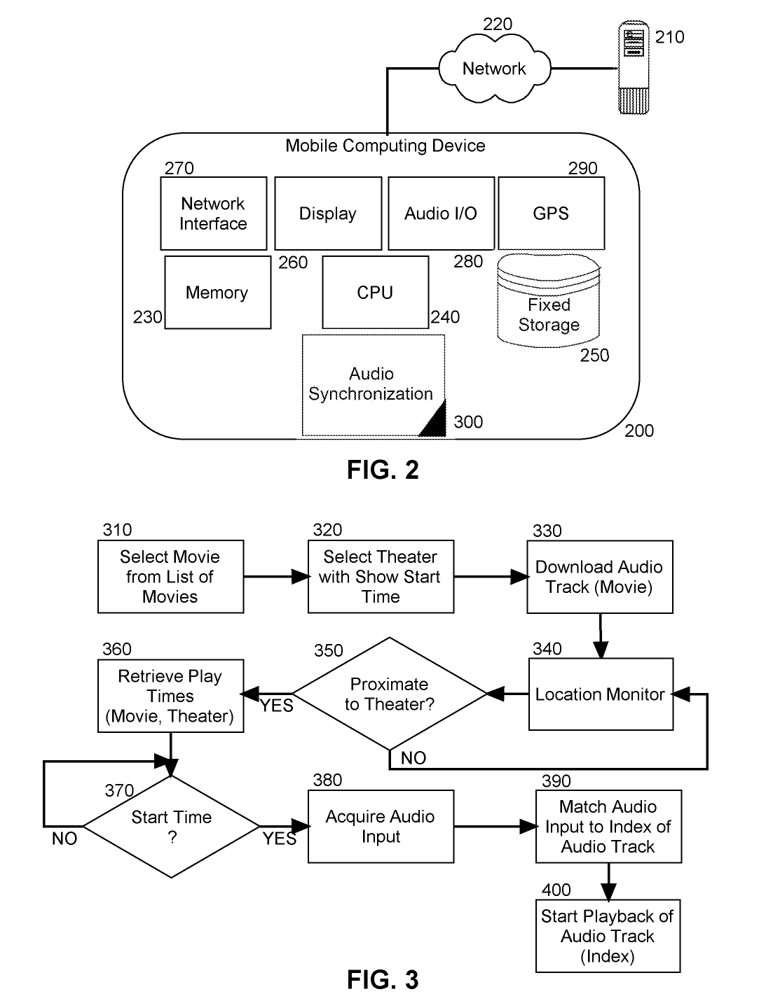

The process described in connection with FIG. 1 may be implemented in a mobile data processing system. In yet further illustration, FIG. 2 schematically illustrates a mobile data processing system configured for the continuous automated audio synchronization of an alternative audio track with the playback of the combined audio and video of a motion picture. The system includes a mobile computing device 200 communicatively coupled to a media server 210 over computer communications network 220. The mobile computing device 200 includes memory 230 and at least one processor 240 and fixed storage 250 such as a solid state memory device. The mobile computing device 200 also includes a display 260, audio input and output 280 (for example a microphone and speakers or audio output port) and a network interface 270 permitting network communications between the mobile computing device 200 and endpoints over the computer communications network 220. Optionally, global positioning system (GPS) circuitry 290 is included in the mobile computing device.

Of note, an audio synchronization module 300 is stored in the fixed storage 250 and executes by the processor 240 once loaded into memory 230. The audio synchronization module 300 includes program code that when executed by the processor 240 retrieves an alternative audio file into the fixed storage 250 from the media server 210 for a selected movie and corresponding movie theater in which the selected movie is scheduled to be presented repeatedly over a period of time. Thereafter, the program code geo-locates the mobile computing device 200, for instance, by accessing the GPS circuitry 290, and determines if the mobile computing device 200 is proximate to the movie theater in which the selected movie is scheduled to be presented repeatedly over a period of time. Then, the program code retrieves a current time in the mobile computing device 200 and retrieves from an information source over the computer communications network 220, a start time of a next presentation of the selected movie.

Once the start time of the next presentation is reached, the program code activates the audio input and output port 280 and receives audio input. The program code then compares the audio input to known audio portions of the selected movie in order to identify a contemporaneously presented portion of the selected movie. Consequently, the program code identifies a contemporaneously presented portion of the selected movie and maps the contemporaneously presented portion to a location in the alternative audio file stored in the fixed storage 250. Finally, the program code directs the playback through the audio input and output port 280 of the alternative audio file from the mapped location. In this way, synchronization of the playback of the alternative audio file is achieved in an automated fashion without requiring the use of embedded watermarks in the selected movie.

In more particular illustration of the operation of the audio synchronization module 300, FIG. 3 is a flow chart illustrating a process for the continuous automated audio synchronization of an alternative audio track with the playback of the combined audio and video of a motion picture. Beginning in block 310, a movie is selected from a list of movies in a user interface in the display of the mobile computing device. In block 320, a theater with start times in which the selected movie is scheduled to be presented repeatedly over a period of time is displayed and selected and in block 330, an alternative audio track for the selected movie is retrieved from over the computer communications network. In block 340, a geo-location of the mobile computing device is monitored and, in decision block 350 it is determined whether or not the mobile computing device has become geographically proximate to the selected movie theater, for instance if the mobile computing device has entered a geo-fenced area associated with the selected movie theater.

In block 360, the play times for the selected movie are retrieved for the movie theater, and the current time as measured on the mobile computing device and compared to the play times for the selected movie. In decision block 370, it is then determined if the play time is the same or within a threshold period of time of the current time as measured by the mobile computing device. If so, in block 380 audio input is acquired through the microphone of the mobile computing device. In block 390, the acquired audio is mapped to an index in the alternative audio track, for instance, by comparing digital features of the acquired audio to pre-stored digital features of different portions of the alternative audio track that are respectively mapped different indexes of the alternative audio track. Finally, in block 400, playback of the alternative audio track commences at the mapped index.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network. The computer readable program instructions may execute entirely on the user's computer, partly on the user's computer, as a stand-alone software package, partly on the user's computer and partly on a remote computer or entirely on the remote computer or server. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

1. A method for the continuous automated audio synchronization of an alternative audio track with the playback of the combined audio and video of a motion picture, the method comprising:
selecting a motion picture in a user interface to an audio synchronization application executing in memory of a mobile computing device;
downloading an alternative audio file for the selected motion picture;
detecting a location of the mobile computing device; and,
responsive to a determination that the mobile computing device is proximate to a movie theater, determining a start time of a next scheduled presentation of the selected motion picture and triggering audio synchronization of the alternative audio file by the application at a time that is within a threshold of the determined start time.

2. The method of claim 1, wherein the audio synchronization comprises:
receiving audio through a microphone of the mobile computing device;
selecting a portion of the received audio;
comparing the portion of the received audio to pre-stored audio portions in a table in the mobile computing device that maps the pre-stored audio portions to an index into the alternative audio file;
matching the portion of the received audio to one of the pre-stored audio portions in the table; and,
playing back the alternative audio file in the mobile computing device from a location indicated by an index mapped to the mapped one of the pre-stored audio portions.

3. The method of claim 1, further comprising:
geo-fencing multiple different movie theaters; and,
determining that the mobile computing device is proximate to the movie theater when the mobile computing device is geo-located within a geo-fence corresponding to the movie theater.

4. The method of claim 1, further comprising:
determining that audio synchronization of the alternative audio file has failed; and,
in response to determining that the audio synchronization of the alternative audio file has failed, re-triggering audio synchronization.

5. The method of claim 4, further comprising:
discontinuing audio synchronization of the alternative audio file in response to a manual directive received in the mobile computing device.

6. A mobile data processing system configured for the continuous automated audio synchronization of an alternative audio track with the playback of the combined audio and video of a motion picture, the system comprising:
a mobile computing device with memory and at least one processor;
fixed storage disposed in the mobile computing device; and,
an audio synchronization application executing in the memory of the mobile computing device, the application comprising program code enabled upon execution to select a motion picture in a user interface to the application, download into the fixed storage an alternative audio file for the selected motion picture, detect a location of the mobile computing device, and to respond to a determination that the mobile computing device is proximate to a movie theater by determining a start time of a next scheduled presentation of the selected motion picture and triggering audio synchronization of the alternative audio file at a time that is within a threshold of the determined start time.

7. The system of claim 6, wherein the program code of the application performs the audio synchronization by:
receiving audio through a microphone of the mobile computing device;
selecting a portion of the received audio;
comparing the portion of the received audio to pre-stored audio portions in a table in the mobile computing device that maps the pre-stored audio portions to an index into the alternative audio file;
matching the portion of the received audio to one of the pre-stored audio portions in the table; and,
playing back the alternative audio file in the mobile computing device from a location indicated by an index mapped to the mapped one of the pre-stored audio portions.

8. The system of claim 6, wherein the program code additionally:
geo-fences multiple different movie theaters; and,
determines that the mobile computing device is proximate to the movie theater when the mobile computing device is geo-located within a geo-fence corresponding to the movie theater.

9. The system of claim 6, wherein the program code of the application additionally
determines that audio synchronization of the alternative audio file has failed; and,
in response to determining that the audio synchronization of the alternative audio file has failed, re-triggers audio synchronization.

10. The system of claim 9, wherein the program code of the application additionally:
discontinues audio synchronization of the alternative audio file in response to a manual directive received in the mobile computing device.

11. A computer program product for the continuous automated audio synchronization of an alternative audio track with the playback of the combined audio and video of a motion picture, the computer program product comprising a non-transitory computer readable storage medium having program instructions embodied therewith, the program instructions executable by a device to cause the device to perform a method comprising:
selecting a motion picture in a user interface to an audio synchronization application executing in memory of a mobile computing device;
downloading an alternative audio file for the selected motion picture;
detecting a location of the mobile computing device; and,
responsive to a determination that the mobile computing device is proximate to a movie theater, determining a start time of a next scheduled presentation of the selected motion picture and triggering audio synchronization of the alternative audio file at a time that is within a threshold of the determined start time.

12. The computer program product of claim 11, wherein the audio synchronization comprises:
receiving audio through a microphone of the mobile computing device;
selecting a portion of the received audio;
comparing the portion of the received audio to pre-stored audio portions in a table in the mobile computing device that maps the pre-stored audio portions to an index into the alternative audio file;
matching the portion of the received audio to one of the pre-stored audio portions in the table; and,
playing back the alternative audio file in the mobile computing device from a location indicated by an index mapped to the mapped one of the pre-stored audio portions.

13. The computer program product of claim 11, further comprising:
geo-fencing multiple different movie theaters; and,
determining that the mobile computing device is proximate to the movie theater when the mobile computing device is geo-located within a geo-fence corresponding to the movie theater;

14. The computer program product of claim 11, further comprising:
determining that audio synchronization of the alternative audio file has failed; and,
in response to determining that the audio synchronization of the alternative audio file has failed, re-triggering audio synchronization.

15. The computer program product of claim 14, further comprising:
discontinuing audio synchronization of the alternative audio file in response to a manual directive received in the mobile computing device.
